(19) United States
(12) Patent Application Publication
(10) Pub. No.: US 2017/0090916 A1
(43) Pub. Date: Mar. 30, 2017

(54) ANALYSIS METHOD AND ANALYSIS APPARATUS

(71) Applicant: FUJITSU LIMITED, Kawasaki-shi (JP)

(72) Inventors: Kiyoshi NISHIKAWA, Ebina (JP); AKIHIKO MATSUO, Yokohama (JP)

(73) Assignee: FUJITSU LIMITED, Kawasaki-shi (JP)

(21) Appl. No.: 15/262,836

(22) Filed: Sep. 12, 2016

(30) Foreign Application Priority Data
Sep. 30, 2015 (JP) 2015-192558

(51) Int. Cl. G06F 9/44

(52) U.S. Cl. CPC G06F 8/71

(57) ABSTRACT

An analysis apparatus detects dependency relationships between a plurality of code units, classifies the plurality of code units into clusters, based on the dependency relationships, and acquires directory information indicating which of directories each of the plurality of code units belongs to. The analysis apparatus counts, for at least one of the directories, the number of code units belonging to the one directory in each of the clusters. The analysis apparatus calculates an evaluation value indicating the dispersion status of the code units belonging to the one directory, based on the distribution of the number of code units among the clusters.

### CROSS-REFERENCE TO RELATED APPLICATION

This application is based upon and claims the benefit of priority of the prior Japanese Patent Application No. 2015-192558, filed on Sep. 30, 2015, the entire contents of which are incorporated herein by reference.

### FIELD

The embodiments discussed herein are related to an analysis method and an analysis apparatus.

### BACKGROUND

When developing new application software that runs on an information processing system, various types of design information are usually created. Although such design information that is created during development of new application software is useful for later maintenance and modifications to the application software, the design information is often no longer stored when performing maintenance and modifications. Further, in the case where minor modifications are repeatedly made to the application software after the application software is put into operation, design information on the modifications is sometimes not created or stored. Then, stored design information might not match the application software that is currently implemented.

One way to address this issue is to analyze implementation code such as source code and object code and thereby identify the current structure of the application software.

For example, there has been proposed a dependency measurement apparatus that quantitatively evaluates the dependency between software modules. The proposed dependency measurement apparatus extracts a plurality of classes from the source code, and extracts attributes, method arguments, method calls, and so on, from each class. The dependency measurement apparatus calculates, for each combination of two classes, the dependency between the two classes based on the extracted attributes, method arguments, method calls, and so on, using a predetermined calculation formula.

There has also been proposed a software structure analysis apparatus that analyzes the differences between the software structure intended by the designer and the current software structure that has been modified. The proposed software structure analysis apparatus analyzes a plurality of source code units, and extracts dependency relationships such as function calls between the source code units. Further, the software structure analysis apparatus acquires arrangement information indicating the arrangement of logical blocks, and associates the logical blocks with the source code units. The software structure analysis apparatus converts the dependency relationships between the source code units into dependency relationships between the logical blocks. Then, the software structure analysis apparatus detects, as a problematic dependency relationship, a dependency relationship not conforming to a preferable dependency relationship that is determined based on the arrangement information.

There has also been proposed a dependency relationship evaluation apparatus that determines a set of development products as an independent unit of work, based on dependency relationships between a plurality of development products. The proposed dependency relationship evaluation apparatus extracts dependency relationships between development products of an upstream process, such as specifications, and development products of a downstream process, such as source code units. Then, the dependency relationship evaluation apparatus calculates the complexity of each dependency relationship. Based on the calculated complexity, the dependency relationship evaluation apparatus determines, as a unit of work such as analysis work and modification work, a set of development products spanning across the upstream process and the downstream process and easily separable from other development products.

There has also been proposed an analysis support apparatus that visualizes the discrepancy between the initial software structure and the current software structure. The proposed analysis support apparatus divides a set of source code units into a plurality of clusters, based on the current dependency relationships between the source code units. Further, the analysis support apparatus acquires information indicating the initial corresponding relationships between the source code units and business classifications. The analysis support apparatus generates a two-dimensional segment for each cluster, and arranges two or more figures corresponding to two or more source code units belonging to the cluster in the two-dimensional segment. Further, the analysis support apparatus displays each figure arranged in the two-dimensional segments in a color corresponding to the business classification to which the corresponding code unit belongs. In some cases, figures of different colors are arranged in a single two-dimensional segment.

See, for example, Japanese Laid-open Patent Publications. No. 2000-215045, No. 2011-170697, No. 2013-15958, and No. 2013-152576.

According to the analysis support apparatus described above, the overall trend of the discrepancy between the initial business classifications and the current clusters is visualized by using a set of figures. The overall trend of the discrepancy is represented by the figures of different colors. However, the analysis support apparatus provides only an intuitive understanding of the overall trend of the discrepancy. Therefore, it is not easy to objectively determine the quality of the current software structure based only on the visualized information provided by the analysis support apparatus. Thus, a detailed analysis is often performed using another analysis method. Moreover, it is not easy to compare the quality of software structure between different pieces of application software.

### SUMMARY

According to one aspect, there is provided an analysis method. The analysis method includes: detecting, by a processor, dependency relationships between a plurality of code units describing processing performed by software, classifying the plurality of code units into a plurality of clusters, based on the dependency relationships, and acquiring directory information indicating which of a plurality of directories each of the plurality of code units belongs to; counting, by the processor, for at least one directory of the plurality of directories indicated by the directory information, a number of code units belonging to the one directory in each of the plurality of clusters; and calculating, by the processor, an evaluation value indicating a dispersion status of the code units belonging to the one directory, based on a distribution of the number of code units among the plurality of clusters.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an analysis apparatus according to a first embodiment;

FIG. 2 is a block diagram illustrating an example of hardware of an analysis apparatus according to a second embodiment;

FIG. 3 is an exemplary functional block diagram of the analysis apparatus according to the second embodiment;

FIG. 4 illustrates an example of source code;

FIG. 5 illustrates an example of a call graph;

FIG. 6 illustrates an example of an adjacency matrix;

FIG. 7 illustrates an example of clustering of source code;

FIG. 8 illustrates an example of a cluster table and a label table;

FIG. 9 illustrates an example of a software map;

FIG. 10 illustrates an example of a source code unit count table;

FIG. 11 illustrates a first example of a heat map;

FIG. 12 illustrates a second example of a heat map;

FIG. 13 illustrates a third example of a heat map;

FIG. 14 illustrates a fourth example of a heat map;

FIG. 15 is a graph illustrating an example of a Gaussian function and a half width at half maximum;

FIG. 16 illustrates a first example of an evaluation value table;

FIG. 17 illustrates a second example of an evaluation value table;

FIG. 18 is a flowchart illustrating an example of the procedure of software analysis;

FIG. 19 is a flowchart illustrating an example of the procedure of clustering;

FIG. 20 is a flowchart illustrating an example of the procedure of association processing; and

FIG. 21 is a flowchart illustrating an example of the procedure of evaluation value calculation.

### DESCRIPTION OF EMBODIMENTS

Several embodiments will be described below with reference to the accompanying drawings, wherein like reference numerals refer to like elements throughout.

### (a) First Embodiment

The following describes a first embodiment.

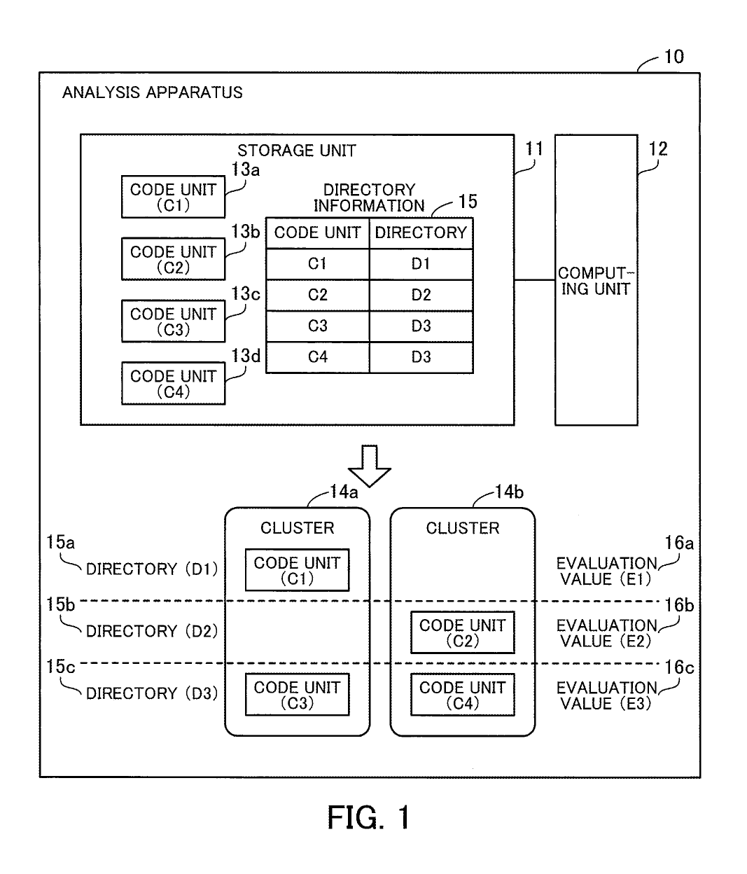

FIG. 1 illustrates an example of an analysis apparatus according to a first embodiment.

An analysis apparatus 10 of the first embodiment quantitatively evaluates the quality of the overall structure of software. The analysis apparatus 10 may be a terminal apparatus such as a client computer and the like that is operated by the user, or may be a server apparatus such as a server computer and the like that is accessed by a terminal apparatus.

The analysis apparatus 10 includes a storage unit 11 and a computing unit 12. The storage unit 11 may be a volatile semiconductor memory such as a random access memory (RAM) and the like, or may be a non-volatile storage such as a hard disk drive (HDD), a flash memory, and the like. Examples of the computing unit 12 include processors such as a central processing unit (CPU), a digital signal processor (DSP), and the like. However, the computing unit 12 may include an application specific electronic circuit such as an application specific integrated circuit (ASIC), a field programmable gate array (FPGA), and the like. The processor executes a program stored in a memory such as a RAM and the like. The programs include an analysis program. A set of multiple processors (a multiprocessor) may also be referred to as a “processor”.

The storage unit 11 stores a plurality of code units describing processing performed by software. The plurality of code units include a code unit 13a (code unit C1), a code unit 13b (code unit C2), a code unit 13c (code unit C3), and a code unit 13d (code unit C4). The code units 13a, 13b, 13c, and 13d correspond to instructions executed by the processor, and may be referred to as a program. The code units 13a, 13b, 13c, and 13d may be source code written in a high-level language, or may be object code written in a machine language or an intermediate language. Each of the code units 13a, 13b, 13c, and 13d corresponds to a unit of processing. The unit of processing may be any unit such as class, method, function, subroutine, and so on. For example, the code units 13a, 13b, 13c, and 13d describe different classes.

The computing unit 12 analyzes the plurality of code units stored in the storage unit 11, and detects dependency relationships between the plurality of code units. The dependency relationships are, for example, calling relationships between units of processing (for example, method calling relationships between classes or the like). The computing unit 12 classifies the plurality of code units including the code units 13a, 13b, 13c, and 13d into a plurality of clusters including clusters 14a and 14b, based on the detected dependency relationships. For example, the computing unit 12 classifies two or more code units with a strong dependency relationship into the same cluster, and classifies code units with a weak dependency relationship into different clusters. For example, the code units 13a and 13c are classified into the cluster 14a, and the code units 13b and 13d are classified into the cluster 14b.

Further, the computing unit 12 acquires directory information 15 indicating which of a plurality of directories, including a directory 15a (directory D1), a directory 15b (directory D2), and a directory 15c (directory D3), each of the plurality of code units belongs to. The directory information 15 is stored in the storage unit 11. A directory is a container for storing files such as the code units 13a, 13b, 13c, and 13d, and the like, and is often referred to as a folder or a package. The directory may be a real directory registered in the file system, or may be a virtual directory for management purposes that is assigned to a code unit.

The directory information 15 may be created by the user, or may be created by the computing unit 12. For example, the computing unit 12 specifies a directory where each of the code units 13a, 13b, 13c, and 13d is stored, based on information on a directory hierarchy managed by the file system. Further, for example, the computing unit 12 extracts the package name included in each of the code units 13a, 13b, 13c, and 13d, and uses the package name as the directory name. For example, the code unit 13a belongs to the directory 15a. The code unit 13b belongs to the directory 15b. The code units 13c and 13d belong to the directory 15c.

The computing unit 12 performs the following processing on at least one directory of the plurality of directories indicated by the directory information 15. The computing unit 12 may perform the following processing on each of the plurality of directories.

The computing unit 12 counts the number of code units belonging to a certain directory in each of the plurality of clusters. In the above example, of the code units belonging to the directory 15a, one is classified in the cluster 14a, and none is classified in the cluster 14b. Of the code units belonging to the directory 15b, none is classified in the cluster 14a, and one is classified in the cluster 14b. Of the code units belonging to the directory 15c, one is classified in the cluster 14a, and one is classified in the cluster 14b.

The computing unit 12 calculates, for a certain directory, the distribution of the number of code units among the plurality of clusters. The computing unit 12 calculates an evaluation value indicating the dispersion status of the code units belonging to the directory, based on the distribution of the number of code units. As described above, the evaluation value may be calculated for one or more or all the directories 15a, 15b, and 15c. For example, the computing unit 12 calculates an evaluation value 16a (evaluation value E1) for the directory 15a, an evaluation value 16b (evaluation value E2) for the directory 15b, and an evaluation value 16c (evaluation value E3) for the directory 15c.

The greater the number of clusters which the code units are dispersed across is, the greater the evaluation values 16a, 16b, and 16c are, for example. The smaller the number of clusters which the code units are concentrated in is, the smaller the evaluation values 16a, 16b, and 16c are. In the above example, the evaluation value 16c is greater than the evaluation values 16a and 16b. Each of the evaluation values 16a, 16b, and 16c may be a value related to the number of clusters including a threshold number of code units or more. For example, the computing unit 12 arranges the plurality of clusters in descending order of the number of code units, and estimates a function (for example, Gaussian function) representing the distribution of the number of code units among the clusters. The computing unit 12 calculates a statistical value such as half width at half maximum (HWHM) and the like, using the estimated function.

The thus calculated evaluation values 16a, 16b, and 16c are an index of the quality of the overall structure of the software, and are regarded as the quantitative evaluation results. For example, if the plurality of evaluation values are small on the whole, it may be determined that, in the software, code units that may be executed in the same period are stored in the same directory and an appropriate functional decomposition is achieved. On the other hand, for example, if the evaluation values of some directories are small and the evaluation values of some other directories are large, it may be determined that the overall structure of the software is not consistent and code units are not appropriately organized. In this case, the inconsistency of the overall structure might be caused by inappropriate maintenance and modifications performed on the newly developed software.

According to the analysis apparatus 10 of the first embodiment, a plurality of code units are classified into a plurality of clusters, based on dependency relationships between the plurality of code units. Further, the directory information 15 is acquired that indicates the storage relationships between the plurality of code units and the plurality of directories. For at least one directory of the plurality of directories, the number of code units belonging to the one directory in each of the plurality of clusters is counted. Then, an evaluation value is calculated that indicates the dispersion status of the code units belonging to the one directory, based on the distribution of the number of code units among the plurality of clusters.

The calculated evaluation value is, for example, displayed on the display so as to be presented to the user. A list of a plurality of evaluation values, a table in which directories are associated with evaluation values, or the like may be displayed on the display. Thus, a quantitative evaluation on the overall structure of the software is provided, so that it is easy to objectively determine the quality of the overall structure. Further, it is easy to compare the quality of the overall structure among different pieces of software. Accordingly, for example, it is possible to evaluate whether maintenance and modifications performed on the newly developed software are appropriate.

### (b) Second Embodiment

The following describes a second embodiment.

An analysis apparatus 100 of the second embodiment analyzes existing source code of existing application software, and visualizes the basic structure (architecture) of the application software. Visualized information generated by the analysis apparatus 100 may be used for evaluating whether maintenance and modifications that have been performed on the application software are appropriate, for example. In particular, the visualized information provides an evaluation indicating whether the maintenance and modifications have been appropriately performed so as to conform to the initial architecture. Further, the visualized information may be used for creating an update plan for the application software, for example.

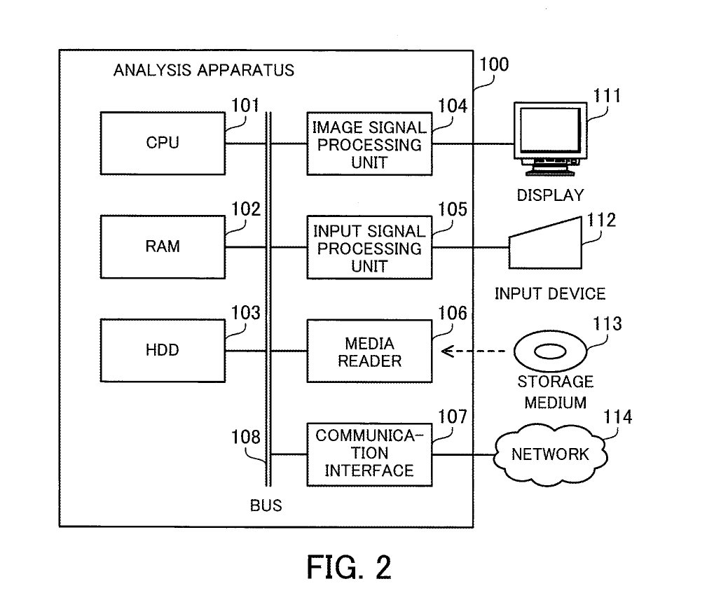

FIG. 2 is a block diagram illustrating an example of hardware of an analysis apparatus according to the second embodiment.

The analysis apparatus 100 includes a CPU 101, a RAM 102, an HDD 103, an image signal processing unit 104, an input signal processing unit 105, a media reader 106, and a communication interface 107. These units are connected to a bus 108. The analysis apparatus 100 corresponds to the analysis apparatus 10 of the first embodiment. The RAM 102 and the HDD 103 correspond to the storage unit 11 of the first embodiment. The CPU 101 corresponds to the computing unit 12 of the first embodiment.

The CPU 101 is a processor including an arithmetic circuit that executes program instructions. The CPU 101 loads at least part of a program and data stored in the HDD 103 to the RAM 102, and executes the program. Note that the CPU 101 may include multiple processor cores, and the analysis apparatus 100 may include multiple processors. Thus, processes described below may be executed in parallel by using multiple processors or processor cores. A set of multiple processors (a multiprocessor) may be referred to as a “processor”.

The RAM 102 is a volatile semiconductor memory that temporarily stores a program executed by the CPU 101 and data used for operations by the CPU 101. The analysis apparatus 100 may include other types of memories than a RAM, and may include a plurality of memories.

The HDD 103 is a non-volatile storage device that stores software programs (such as an operation system (OS), middleware, application software, and the like) and data. The programs include an analysis program. The analysis apparatus 100 may include other types of storage devices such as a flash memory, a solid state drive (SSD), and the like, and may include a plurality of non-volatile storage devices.

The image signal processing unit 104 outputs an image to a display 111 connected to the analysis apparatus 100, in accordance with an instruction from the CPU 101. Examples of the display 111 include a cathode ray tube (CRT) display, a liquid crystal display (LCD), a plasma display, an organic electro-luminescence (OEL) display, and the like.

The input signal processing unit 105 obtains an input signal from an input device 112 connected to the analysis apparatus 100, and outputs the input signal to the CPU 101. Examples of the input device 112 include a pointing device (such as a mouse, a touch panel, a touch pad, a trackball, and the like), a keyboard, a remote controller, a button switch, and the like. A plurality of types of input devices may be connected to the analysis apparatus 100.

The media reader 106 is a reading device that reads a program and data stored in a storage medium 113. Examples of the storage medium 113 include a magnetic disc (such as a flexible disk (FD), an HDD, and the like), an optical disc (such as a compact disc (CD), a digital versatile disc (DVD), and the like), a magneto-optical disc (MO), a semiconductor memory, and the like. The media reader 106 reads, for example, a program and data from the storage medium 113, and stores the read program and data in the RAM 102 or the HDD 103.

The communication interface 107 is connected to a network 114, and communicates with other apparatuses via the network 114. The communication interface 107 may be a wired communication interface connected to a communication apparatus such as a switch via a cable, or may be a radio communication interface connected to a base station via a radio link.

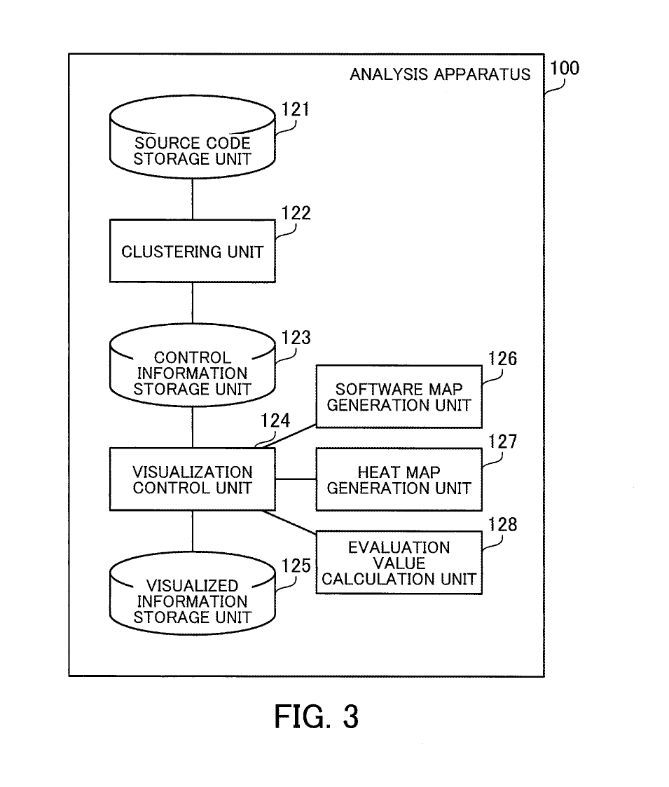

FIG. 3 is an exemplary functional block diagram of the analysis apparatus according to the second embodiment.

The analysis apparatus 100 includes a source code storage unit 121, a clustering unit 122, a control information storage unit 123, a visualization control unit 124, a visualized information storage unit 125, a software map generation unit 126, a heat map generation unit 127, and an evaluation value calculation unit 128. The source code storage unit 121, the control information storage unit 123, and the visualized information storage unit 125 may be implemented using a storage area reserved in the RAM 102 or the HDD 103, for example. The clustering unit 122, the visualization control unit 124, the software map generation unit 126, the heat map generation unit 127, and the evaluation value calculation unit 128 may be implemented using a program, for example.

The source code storage unit 121 stores a set of source code units of the application software under analysis. The source code is a program written in a language that is easily understandable. The source code is provided by a person who requested the analysis, such as the owner, the operator, and the like of the application software. In the second embodiment, a unit of processing is treated as a “unit of source code”. A unit of source code may be a class, method, function, subroutine, or the like. In the following, it is generally assumed that source code is written in an object-oriented language, and a unit of source code is a class.

A set of source code units is managed by a hierarchical directory structure. Each source code unit may describe the name of the directory (the name of the package or the like) to which the source code unit belongs. In this case, the directory to which each source code unit belongs may be specified from the source code unit itself. Further, the set of source code units may be dispersed across a plurality of hierarchical directories. In this case, the directory to which each source code unit belongs may be specified from the location (file path) of the source code unit in the file system. Further, separately from the set of source code units, additional information indicating the directory name assigned to each source code unit may be provided from the person who requested the analysis.

The directory structure of the set of source code units is created in consideration of the overall structure of the application software, and may be regarded as reflecting the design concept of the application software. Thus, even if the specifications of the application software are no longer stored, the analysis apparatus 100 evaluates the architecture of the application software by using the directory structure as information on the design.

The clustering unit 122 reads a set of source code units from the source code storage unit 121 and analyzes the set of source code units. The clustering unit 122 extracts calling relationships (for example, function calls, method calls, and the like) between units of processing described in the source code, and classifies the set of source code units into a plurality of clusters, based on the calling relationships. Two or more source code units strongly connected by a calling relationship are classified into the same culture as far as possible, and source code units weakly connected are classified into different clusters as far as possible.

A cluster is a set of source code units describing units of processing that are likely to be executed in the same period. A cluster may be considered as a “function” of the application software. A cluster and a directory are both used for classifying source code units, but are based on different concepts. Source code units belonging to the same directory may be classified into a small number of clusters in a concentrated manner, or may be classified into a large number of clusters in a dispersed manner. As will be described below, the degree of dispersion of source code units belonging to the same directory is dependent on the architecture adopted at the time of design. In a functionally-partitioned (vertically-partitioned) architecture, each directory usually corresponds to one or a small number of clusters. In a multilayered (horizontally-partitioned) architecture, each directory usually corresponds to a large number of clusters.

Then, the clustering unit 122 stores information indicating the corresponding relationships between the source code units and the clusters in the control information storage unit 123. Further, the clustering unit 122 specifies the directory of each source code unit, and stores information indicating the corresponding relationships between the source code units and the directories in the control information storage unit 123. For example, the clustering unit 122 extracts, from each source code unit, the package name of the source code unit. Further, for example, the clustering unit 122 acquires a file path of each source code unit from the file system managed by the OS. Further, for example, the clustering unit 122 detects the directory of each source code unit from the information provided by the person who requested the analysis. In the case where a plurality of directories are hierarchically arranged, the directory name includes a path from the route directory to the directory immediately above the source code unit.

The control information storage unit 123 stores various types of control information used for visualization of the architecture. The control information includes the results of clustering by the clustering unit 122. That is, the control information storage unit 123 stores information indicating the corresponding relationships among the source code units, the directories, and the clusters. Further, the directory name used in the source code units and the file system may be a simple alphanumeric string written with abbreviations or the like. Therefore, upon visualization, it is sometimes desired to use a label that is easily understandable by humans, in place of such directory name. In this case, information associating the directory names with the directory labels may be provided by the person who requested the analysis and stored in the control information storage unit 123.

The visualization control unit 124 generates visualized information in which the overall structure of the application software is visualized, using the control information stored in the control information storage unit 123. The visualization control unit 124 stores the generated visualized information in the visualized information storage unit 125. Further, the visualization control unit 124 causes the display 111 to display various types of images, using the visualized information stored in the visualized information storage unit 125. In the second embodiment, as will be described below, the visualized information includes three types of information: a software map, a heat map, and directory evaluation values. In order to generate visualized information, the visualization control unit 124 calls the software map generation unit 126, the heat map generation unit 127, and the evaluation value calculation unit 128.

The visualized information storage unit 125 stores visualized information. More specifically, the visualized information storage unit 125 stores a software map generated by the software map generation unit 126, a heat map generated by the heat map generation unit 127, and directory evaluation values generated by the evaluation value calculation unit 128. Part of or all the visualized information stored in the visualized information storage unit 125 is displayed on the display 111 in response to an operation using the input device 112.

The software map generation unit 126 generates a software map, based on the corresponding relationships among the source code units, the directories, and the clusters. The software map includes a plurality of nodes corresponding to a set of source code units. Each node on the software map is displayed in a visual representation (for example, color, pattern, shape, size, and so on) corresponding to the directory to which the corresponding source code unit belongs. Different directories are given different visual representations. Further, each node on the software map is arranged in a position corresponding to the cluster to which the source code unit belongs. Nodes of the same cluster are located close to each other, and nodes of different clusters are located far from each other. With the software map, it is possible to intuitively understand the relationships between the directories and the functions.

The heat map generation unit 127 generates a heat map, based on the corresponding relationships among the source code units, the directories, and the clusters. The heat map is a map in a matrix format in which each row corresponds to a directory and each column corresponds to a cluster. In a position corresponding to one row and one column, a symbol corresponding to the number of source code units belonging to the one directory and the one cluster is displayed. The symbol may be displayed in binary representation indicating whether there is a corresponding source code unit, or may be displayed in multivalued representation that varies depending on the number of corresponding code units. Two or more types of symbols differ in the visual representation such as color, pattern, shape, size, and so on. With the heat map, it is possible to more analytically represent the relationships between the directories and the functions.

The evaluation value calculation unit 128 calculates a directory evaluation value for each directory, based on the corresponding relationships among the source code units, the directories, and the clusters. The directory evaluation value is a statistical value related to how many clusters the source code units belonging to a certain directory are dispersed across. The smaller the number of clusters which the source code units are concentrated in is, the smaller the directory evaluation value is. The greater the number of clusters which the source code units are dispersed across is, the greater the evaluation value is. The directory evaluation value is a value obtained by quantifying the relationship between a directory and functions. It is possible to determine the discrepancy between the initial design concept and the current implementation status based on the directory evaluation value. The software map provides an overview of the relationships between directories and functions, while the directory evaluation values provide a quantitative index of the relationships between directories and functions.

Note that directories above the terminal directories may be used as a unit of analysis for visualization, instead of using the terminal directories, so as to increase the granularity of analysis. The visualization control unit 124 may receive an input for specifying the hierarchical level of directories used as a unit of analysis. The hierarchical level indicates the depth of the hierarchy from the root directory, for example. In this case, the visualization control unit 124 counts, for each directory at the specified hierarchical level, the source code units that are present below the directory.

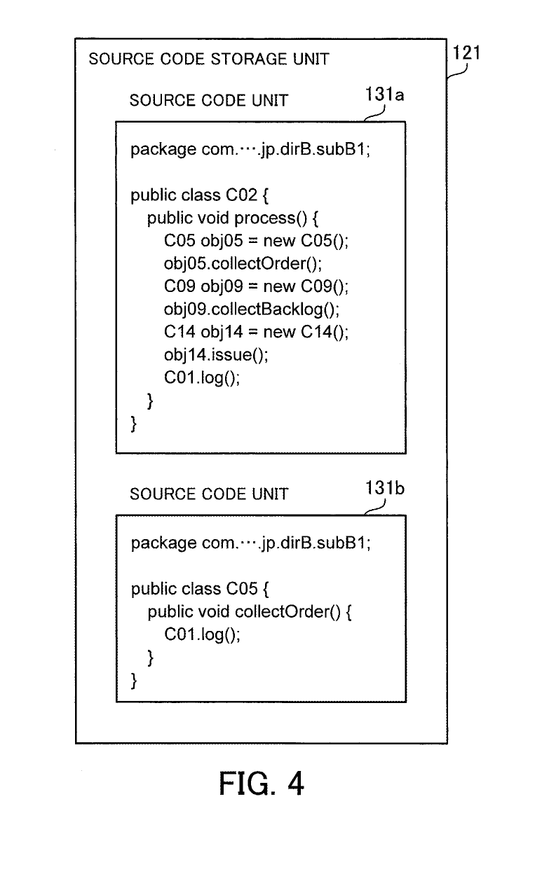

FIG. 4 illustrates an example of source code.

Source code units 131a and 131b are examples of the source code stored in the source code storage unit 121. The source code units 131a and 131b are written in an object-oriented language. Each of the source code units 131a and 131b includes a class.

The source code unit 131a includes a package name “com. . . . .jp.dirB.subB1”. This corresponds to the name of the directory to which the source code unit 131a belongs. Further, the source code unit 131a describes a class C02. The class C02 includes a method “process” that may be called from other classes. The method “process” calls a method “collectOrder” of a class C05, a method “collectBacklog” of a class C09, a method “issue” of a class C14, and a method “log” of a class C01.

The source code unit 131b includes the same package name as that in the source code unit 131a. This indicates that the source code unit 131b belongs to the same directory as the source code unit 131a. Further, the source code unit 131b describes a class C05. The class C05 includes a method “collectOrder” that may be called from other classes. The method “collectOrder” calls a method “log” of the class C01. The clustering unit 122 is able to extract a calling relationship from the source code unit 131a to the source code unit 131b by analyzing the source code units 131a and 131b.

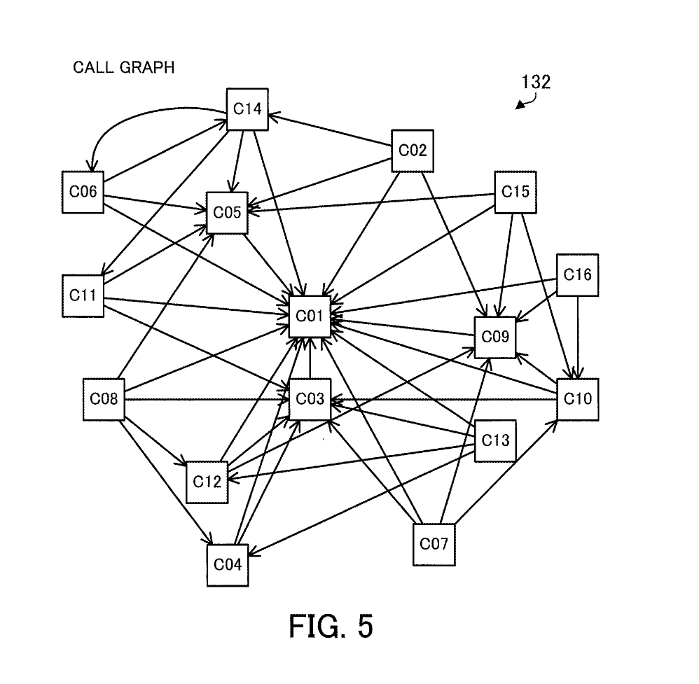

FIG. 5 illustrates an example of a call graph.

In this example, 16 classes C01 to C16 are described in a set of source code units. A call graph 132 is a directed graph representing calling relationships between the classes C01 to C16. The call graph 132 includes a plurality of nodes corresponding to the classes C01 to C16, and a plurality of links representing calling relationships between the classes C01 to C16. The tail of the arrow (source) represents a caller, and the head of the arrow (target) represents a callee. For example, the class C02 calls the classes C01, C05, C09, and C14.

The calling relationships represented by the call graph 132 are weighted. The weight of each calling relationship whose callee is a certain class is inversely proportional to the number of calling relationships whose callee is the certain class. If there are K (K is an integer greater than or equal to 1) calling relationships whose callee is a certain class, a weight of 1/K is applied to each of the K calling relationships. For example, in the call graph 132, there are six calling relationships whose callee is the class C05. Accordingly, a weight of ⅙ is applied to each of the six calling relationships.

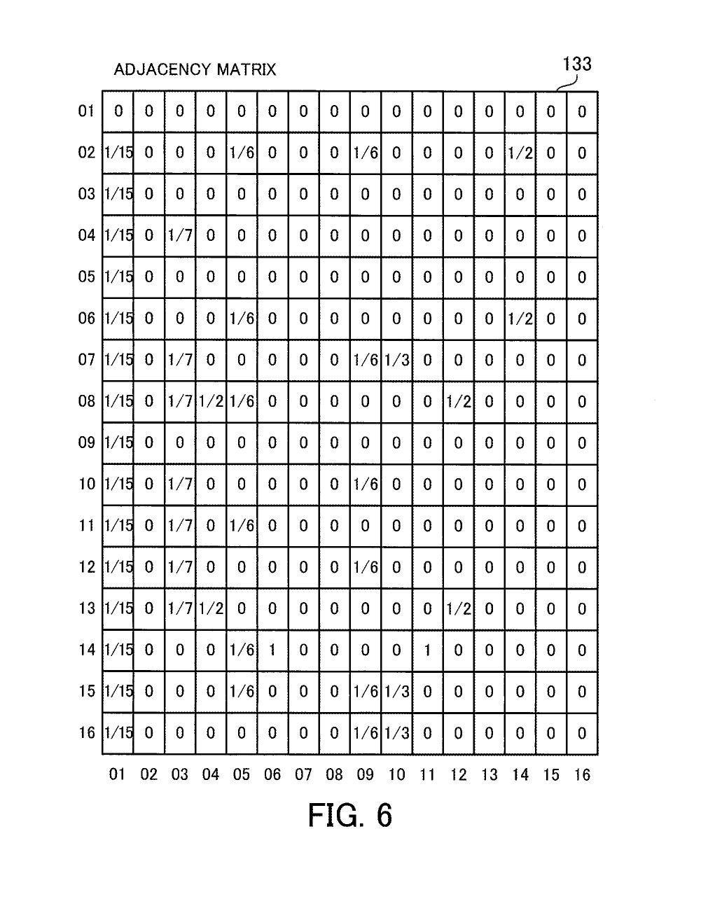

FIG. 6 illustrates an example of an adjacency matrix.

The clustering unit 122 generates an adjacency matrix 133 (adjacency matrix A) by analyzing a set of source code units. Each row of the adjacency matrix 133 corresponds to a calling source code unit, and each column corresponds to a called source code unit. The adjacency matrix 133 corresponds to the call graph 132 of FIG. 5. Since there are 16 source code units corresponding to the classes C01 to C16, the adjacency matrix 133 is a square matrix of 16 rows and 16 columns.

An element (element Aᵢⱼ) in an i-th row and a j-th column of the adjacency matrix 133 represents a method call from a unit of processing described in an i-th source code unit to a unit of processing described in a j-th source code unit. The element Aᵢⱼ is a rational number greater than or equal to 0 and less than or equal to 1. When Aᵢⱼ=0, this indicates that there is no calling relationship from the i-th source code unit to the j-th source code unit. When Aᵢⱼ=1/K, this indicates that there is a calling relationship with a weight of 1/K from the i-th source code unit to the j-th source code unit. For example, an element in the second row and the fifth column of the adjacency matrix 133 is ⅙. This indicates that there is a calling relationship with a weight of ⅙ from a second source code unit to a fifth source code unit.

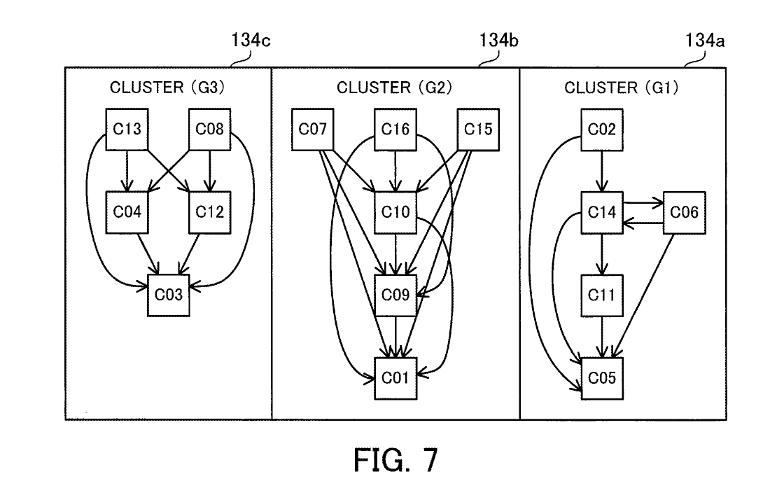

FIG. 7 illustrates an example of clustering of source code.

The clustering unit 122 divides a set of source code units into a plurality of clusters, using the adjacency matrix 133 representing calling relationships between source code units. Each cluster includes one or more source code units. Basically, source code units with a strong calling relationship are located in the same cluster, and source code units with a weak calling relationship are located in different clusters.

For example, clusters 134a, 134b, and 134c (clusters G1 to G3) are generated. The cluster 134a includes five source code units corresponding to the classes C02, C05, C06, C11, and C14. The cluster 134b includes six source code units corresponding to the classes C01, C07, C09, C10, C15, and C16. The cluster 134c includes five source code units corresponding to the classes C03, C04, C08, C12, and C13.

For dividing a set of source code units into clusters, a modularity evaluation value Q represented by an equation (1) is used. The modularity value Q is a rational number greater than or equal to −1 and less than or equal to 1. The greater the modularity value Q is, the higher the quality of clustering is. The smaller the modularity value Q is, the lower the quality of clustering is.

$$Q = \frac{1}{m} {\sum }_{i , j} \{ ( {A}_{ij} - \frac{{k}_{i}^{out} {k}_{j}^{in}}{m} ) δ ( {g}_{i} , {g}_{j} ) \} where \\ m = {\sum }_{i} {\sum }_{j} {A}_{ij} , {k}_{i}^{out} = {\sum }_{j} {A}_{ij} , {k}_{j}^{in} = {\sum }_{i} {A}_{ij} \qquad ( 1 )$$

In equation (1), m is the sum of all the elements in the adjacency matrix 133. Further, kᵢ^{out} is the sum of the elements in the i-th row of the adjacency matrix 133, that is, the sum of the weights of the calling relationships whose caller is the i-th source code unit. Further, kⱼⁱⁿ is the sum of the elements in the j-th column of the adjacency matrix 133, that is, the sum of the weights of the calling relationships whose callee is the j-th source code unit. Further, gᵢ represents the cluster to which the i-th source code unit belongs, and gⱼ represents the cluster to which the j-th source code unit belongs. Further, δ(gᵢ, gⱼ) is a Kronecker delta function. If gᵢ and gⱼ are the same, then δ(gᵢ, gⱼ)=1. If gᵢ and gⱼ are different, then δ(gᵢ, gⱼ)=0. That is, δ(gᵢ, gⱼ) reflects a calling relationship in the same cluster to the modularity evaluation value Q, and ignores a calling relationship between different clusters.

The clustering unit 122 divides a set of source code units into a plurality of clusters so as to maximize the modularity evaluation value Q. The details of the procedure of clustering will be described below. Thus, the cluster to which each source code unit belongs is determined. Further, as illustrated in FIG. 4, in the case where each source code unit describes the package name, the directory to which each source code unit belongs is specified based on the source code itself.

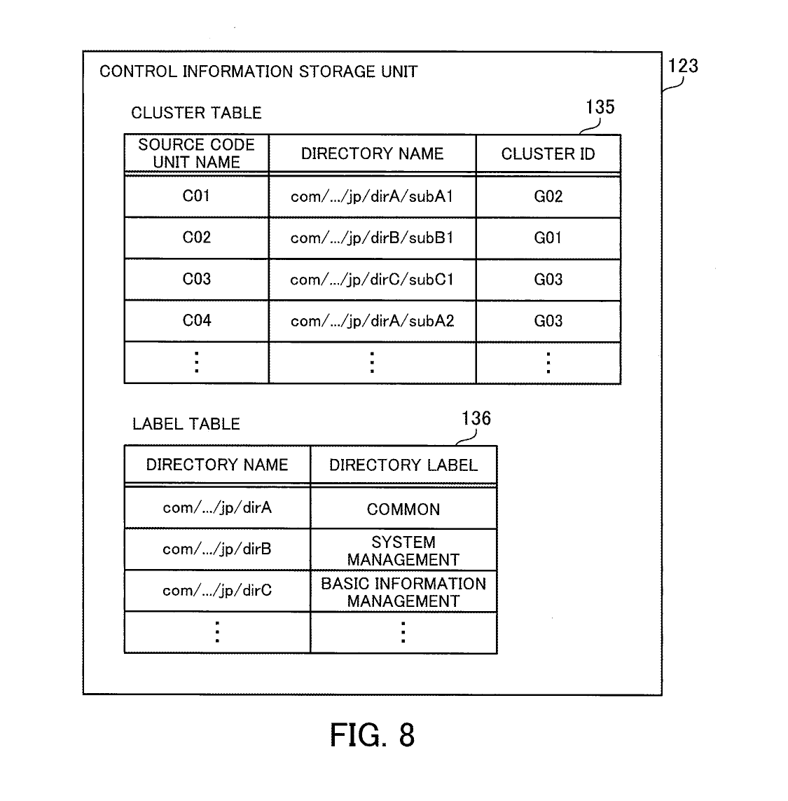

FIG. 8 illustrates an example of a cluster table and a label table.

The clustering unit 122 generates a cluster table 135. The cluster table 135 is stored in the control information storage unit 123. The cluster table 135 includes the following items: source code unit name, directory name, and cluster ID.

The source code unit name is the name that identifies a source code unit. In the cluster table 135 of FIG. 8, the class name is used as the source code unit name. The directory name is the name of a directory to which the source code unit belongs. In the case where a plurality of directories are hierarchically arranged, the directory name includes a path from the route directory to the directory immediately above the source code unit, that is, the directory to which the source code unit belongs. The cluster ID is the name that identifies a cluster. Each source code unit name is associated with a directory name and a cluster ID.

As mentioned above, information indicating the corresponding relationships between the directory names and the directory labels may be provided by the person who requested the analysis. In this case, a label table 136 is stored in the control information storage unit 123. The label table 136 includes the following items: directory name, and directory label. The directory name is the name of a directory including one or more source code units or a directory above that directory. The directory label is an easily understandable name indicating the role of the directory. The directory label is assigned by the person who requested the analysis, for example. However, a person other than the person who requested the analysis, such as the analyst and the like, may assign a directory label.

As mentioned above, in order to increase the granularity of analysis, directories above the terminal directories may be used as a unit of analysis instead of using the terminal directories. In this case, it is preferable that the directory names included in the label table 136 are the names of the directories used as a unit of analysis. For example, assume that the directory name of the source code unit describing the class C01 is “com/ . . . /jp/dirA/subA1”, and the directory name describing the class C04 is “com/ . . . /jp/dirA/subA2”. Further, assume that “com/ . . . /jp/dirA” is assigned with a directory label “COMMON”. In this case, the source code units describing the classes C01 and C04 are regarded as belonging to the same unit of analysis, that is, the same directory in terms of analysis, and that directory is treated as being assigned with the directory name “COMMON”.

Based on the cluster table 135 and the label table 136 described above, the architecture of the application software is visualized. The following describes a software map, a heat map, and directory evaluation values obtained as the results of visualization.

First, a software map will be described.

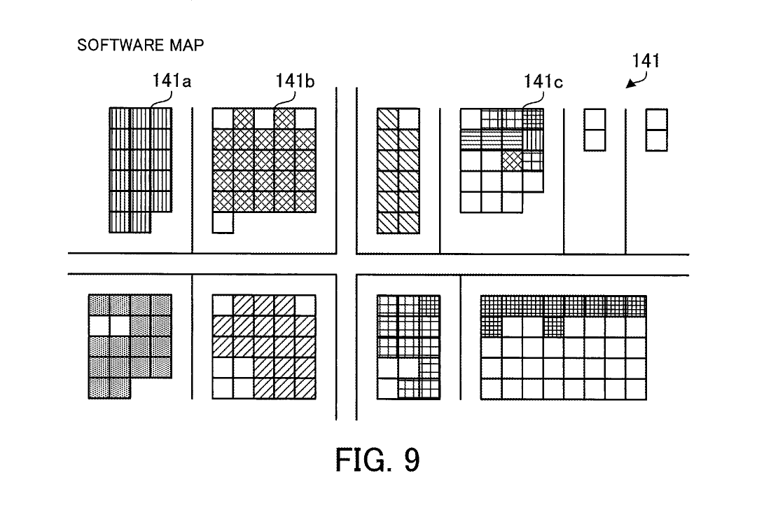

FIG. 9 illustrates an example of a software map.

A software map 141 is generated by the software map generation unit 126, based on the cluster table 135. The information of the software map 141 is stored in the visualized information storage unit 125. Further, the software map 141 is displayed on the display 111. The software map 141 includes a plurality of nodes representing source code units. A pattern is applied to each of the plurality of nodes. Different patterns are applied depending on which directory the source code unit belongs to. Further, the plurality of nodes are divided into blocks in accordance with the cluster to which each source code unit belongs. The nodes corresponding to the source code units belonging to the same cluster are located in the same block.

All the nodes included in a block 141a have the same pattern. This indicates that the cluster corresponding to the block 141a includes only the source code units belonging to the same directory. Further, many of the nodes included in a block 141b have the same pattern. Thus, in the software map 141 of FIG. 9, many of the blocks include nodes of a few patterns. In such a block, a directory corresponds to a set of units of processing that are executed in the same period (function).

On the other hand, nodes included in a block 141c have various patterns. This indicates that the source code units belonging to the cluster corresponding to the block 141c are dispersed across various directories. That is, the source code units describing units of processing that are executed in the same period are dispersed across a large number of directories, and a directory does not correspond to a function.

If blocks in which a directory corresponds to a function and blocks in which a directory does not correspond to a function are both included in the software map 141, there may be a discrepancy between the initial design concept and the current implementation status. For example, although directories and functions were made to correspond to each other in the initial development stage of the application software, it is likely that maintenance and modifications that brake the architecture built in the initial development stage were performed thereafter. In this case, a determination is made that the performed maintenance and modifications are inappropriate and it is preferable to correct the application software. However, although the software map 141 provides an intuitive understanding of the relationships between the directories and functions, the software map 141 does not provide a quantitative index of the degree of discrepancy between the design concept and the implementation status.

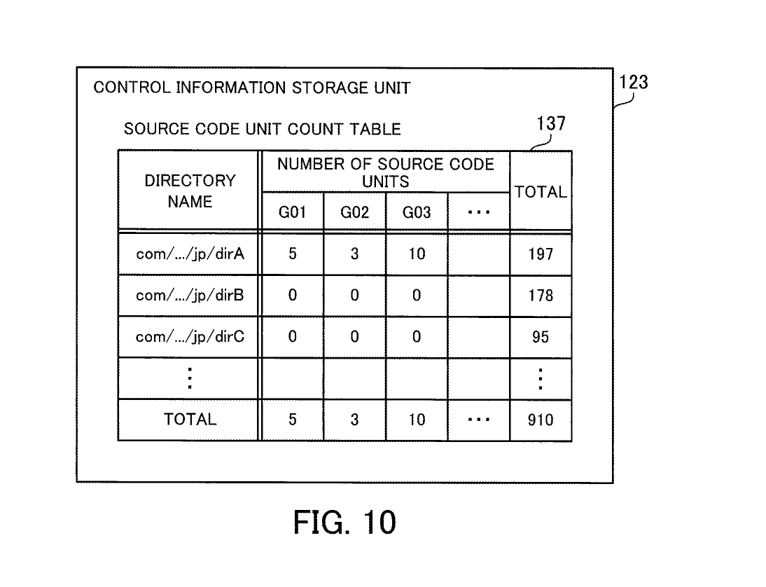

FIG. 10 illustrates an example of a source code unit count table.

For generating a heat map and calculating directory evaluation values, the visualization control unit 124 generates a source code unit count table 137, based on the cluster table 135. The source code unit count table 137 is stored in the control information storage unit 123.

The source code unit count table 137 is a matrix including the directory name as the row item and the cluster ID as the column item. The directory name is the name of a directory used as a unit of analysis. The source code unit count table 137 represents the number of source code units belonging to one directory and belonging to one cluster. The number of source code units may be calculated by finding and counting the corresponding records from the cluster table 135.

For example, in the source code unit count table 137 of FIG. 10, out of 910 source code units, five source code units belong to “com/ . . . /jp/dirA” and belong to a cluster G01. Further, three source code units belong to “com/ . . . /jp/dirA” and belong to a cluster G02. Further, ten source code units belong to “com/ . . . /jp/dirA” and belong to a cluster G03. The number of source code units belonging to each directory may be counted by adding up the number of source code units indicated in the corresponding row of the source code unit count table 137. Further, the number of source code units belonging to each cluster may be counted by adding up the number of source code units indicated in the corresponding column of the source code unit count table 137.

The following describes a heat map.

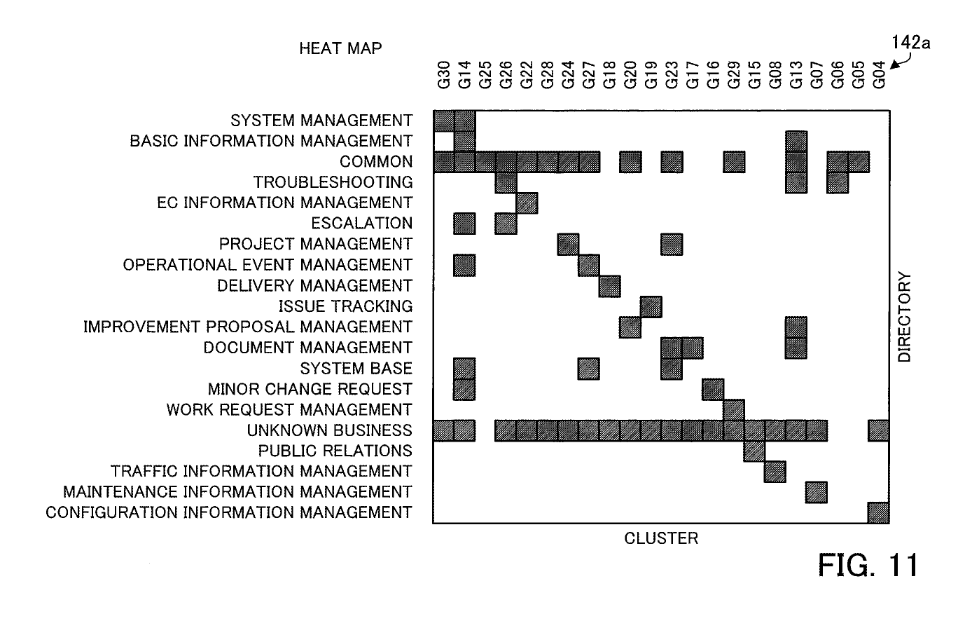

FIG. 11 illustrates a first example of a heat map.

A heat map 142a is generated by the heat map generation unit 127, based on the source code unit count table 137. The information of the heat map 142a is stored in the visualized information storage unit 125. Further, the heat map 142a is displayed on the display 111.

In the heat map 142a, each row corresponds to a directory label, and each column corresponds to a cluster ID. A white or black symbol (a binary symbol) is arranged in a position specified by one directory label and one cluster ID, depending on the number of source code units belonging to the directory and belonging to the cluster. A white symbol indicates that there is no corresponding source code unit (the number of source code units is zero). A black symbol indicates that there is a corresponding source code unit (the number of source code units is 1 or greater).

The cluster IDs are sorted in descending order of the number of source code units belonging to the respective clusters. The directory labels are sorted in accordance with the order of cluster IDs such that black symbols are arranged as diagonally as possible. That is, the directory labels are sorted such that, among the directories with source code units belonging to a certain cluster, the directory with the maximum number of source code units is assigned a rank corresponding to the rank of the cluster.

In the example of the heat map 142a, the directories “COMMON” and “UNKNOWN BUSINESS” are presumed to be shared libraries used by various functions. As for the directories other than the shared libraries, there is a trend that directories and clusters generally correspond one-to-one. Accordingly, the architecture represented by the heat map 142a is regarded as a functionally-partitioned (vertically-partitioned) architecture. Further, since there is generally a one-to-once correspondence between directories other than shared libraries and clusters, the discrepancy between the design concept and the current implementation status is determined to be small.

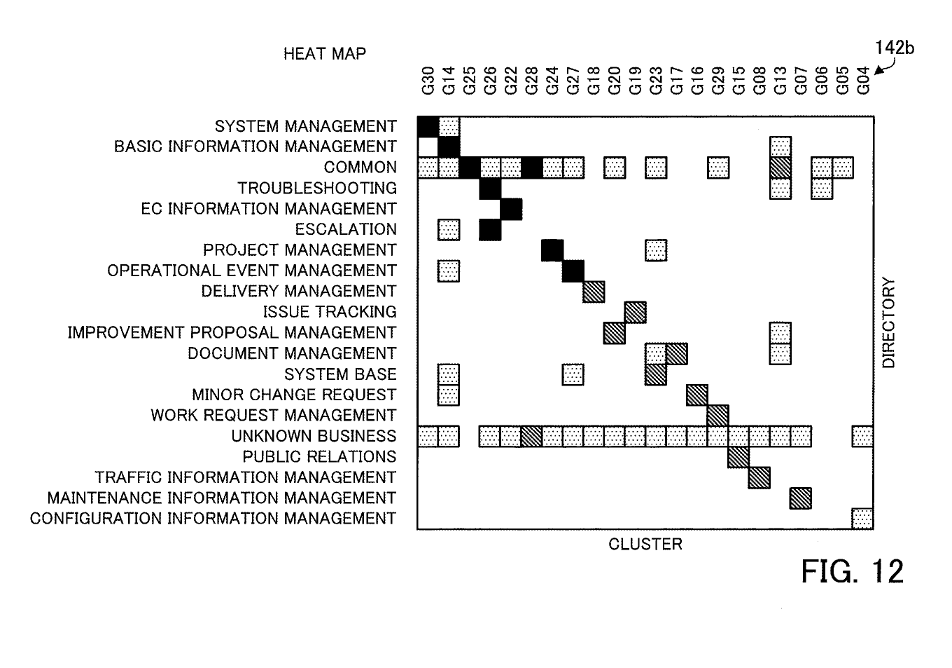

FIG. 12 illustrates a second example of a heat map.

The heat map 142a described above uses binary symbols that indicate whether there is a corresponding source code unit. On the other hand, a heat map 142b uses multivalued symbols to which different patterns are applied depending on the number of corresponding source code units.

Since the cluster IDs are arranged in descending order of the number of source code units, the symbol at the top left indicates that there are a large number of source code units. Further, since directories other than shared libraries and clusters generally correspond one-to-one, the symbols arranged in a diagonal line indicate that there are a large number of source code units. On the other hand, symbols arranged away from the diagonal line, such as the symbols corresponding to shared libraries, indicate that there are a small number of source code units. Thus, using multivalued symbols makes it easier to understand the relationships between directories and clusters.

Note that the heat maps 142a and 142b illustrate examples in which the discrepancy between the design concept and the current implementation status is small. On the other hand, in the case where the discrepancy between the design concept and the current implementation status is large, as for some directories presumed not to be shared libraries, a large number of binary symbols or multivalued symbols appear in locations away from the diagonal line. Thus, it is possible to determine that there is a discrepancy between the design concept and the current implementation status. Further, it is possible to identify the directory or function causing the discrepancy, and identify inappropriate maintenance and modifications.

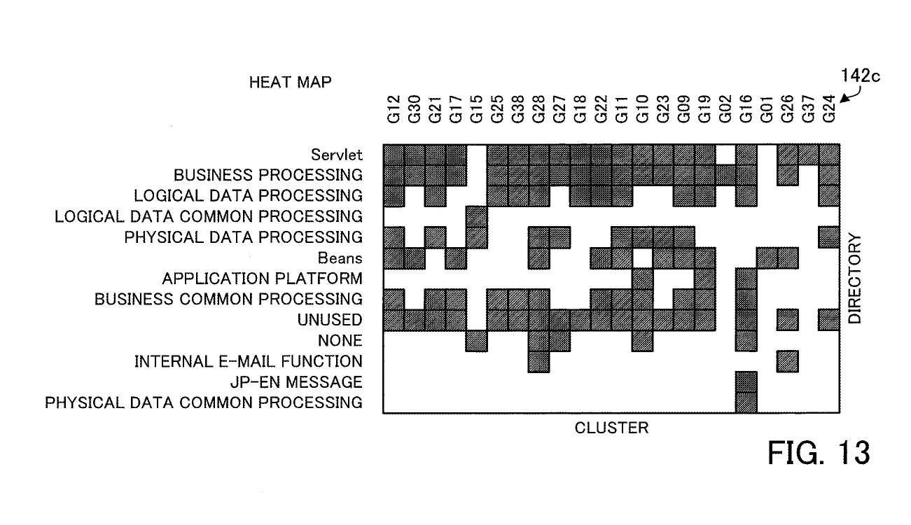

FIG. 13 illustrates a third example of a heat map.

Similar to the heat map 142a, a heat map 142c uses binary symbols. However, the heat map 142c is generated based on a set of source code units different from that of the heat map 142a. The heat map 142a illustrates a functionally-partitioned (vertically-partitioned) architecture in which directories other than shared libraries and clusters generally correspond one-to-one. On the other hand, the heat map 142c illustrates a multilayered (horizontally-partitioned) architecture in which directories correspond to processing layers.

The processing layers include a user interface layer, a control layer, a business logic layer, data access layer, a data layer, and so on. Many functions are implemented by using all or many of the plurality of processing layers. Accordingly, in the multilayered architecture, source code units belonging to the same directory are dispersed across a large number of clusters. In the example of the heat map 142c, directories such as “Servlet”, “BUSINESS PROCESSING”, “LOGICAL DATA PROCESSING” “Beans”, and so on are related to many clusters.

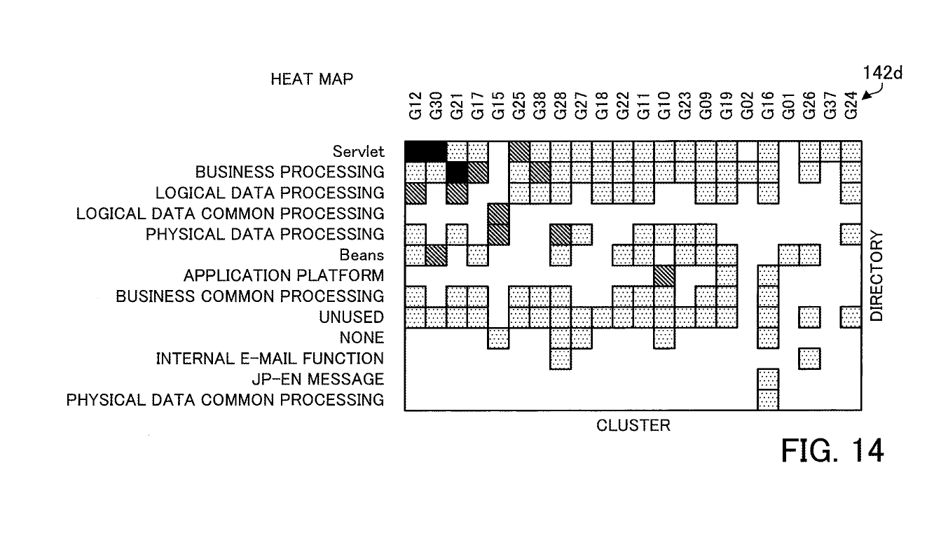

FIG. 14 illustrates a fourth example of a heat map.

The heat map 142c described above uses binary symbols that indicate whether there is a corresponding source code unit. On the other hand, similar to the heat map 142b, a heat map 142d uses multivalued symbols to which different patterns are applied depending on the number of corresponding source code units. Some of the symbols at the top left of the heat map 142d indicate that there are a relatively large number of source code units. However, since the source code units belonging to each directory are classified into a large number of clusters in a dispersed manner, many of the symbols indicate that there are a small number of source code units.

The following describes a directory evaluation value.

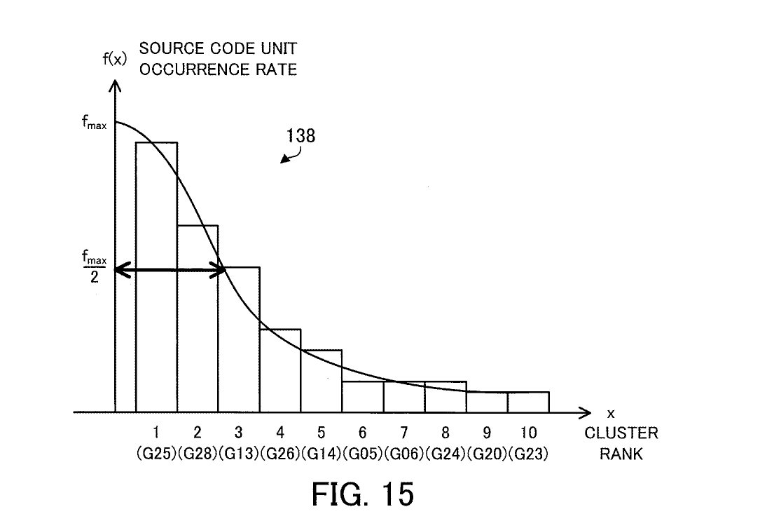

FIG. 15 is a graph illustrating an example of a Gaussian function and a half width at half maximum.

The directory evaluation value is a quantitative index indicating, for each directory, how many clusters the source code units belonging to the directory are dispersed across. The evaluation value calculation unit 128 sorts, for a certain directory, clusters in descending order of the number of source code units belonging to the directory, and assigns a cluster rank represented by a positive integer to each cluster. In the example of a graph 138 of FIG. 15, clusters G25, G28, G13, G26, G14, G05, G06, G24, G20, and G23 are sorted in this order. Further, the evaluation value calculation unit 128 normalizes the number of source code units of each cluster, using the total number of source code units belonging to the directory. That is, the evaluation value calculation unit 128 converts the number of source code units of each cluster into the source code unit occurrence rate, by dividing the number of source code units of the cluster by the total number of source code units.

The evaluation value calculation unit 128 calculates a Gaussian function given by the following equation (2) such that the graph 138 most appropriately represents the relationship between the cluster rank and the source code unit occurrence rate. In equation (2), x is the cluster rank, and f(x) is the source code unit occurrence rate corresponding to the cluster rank x. Further, B is a coefficient representing the amplitude; μ is the mean of the Gaussian function; and σ is the standard deviation (square root of variance). The evaluation value calculation unit 128 considers the coefficient B, the mean μ, and the standard deviation σ as unknown parameters, and determines the values of these parameters such that the Gaussian function best fits the relationship between the cluster rank and the source code appearance rate.

$$f ( x ) = \frac{B}{\sqrt{2 π} σ} exp \{ - \frac{{( x - μ )}^{2}}{2 {σ}^{2}} \} \qquad ( 2 )$$

Although the Gaussian function is calculated based on the assumption that the Gaussian function is symmetric, since the source code unit occurrence rate f(x) corresponding to the cluster rank x=0 does not exist, the mean μ is not always 0. For example, the evaluation value calculation unit 128 may set the coefficient B=1, the mean μ=1, and the standard deviation σ=1 to calculate an index, such as the sum of squared residuals, indicating how well the Gaussian function is fitted, and thereby determine the most appropriate coefficient B, mean μ, and standard deviation σ by trial and error.

Then, the evaluation value calculation unit 128 calculates a half width at half maximum (HWHM) as the directory evaluation value, based on the determined Gaussian function. When fₘₐₓ is the maximum value of the source code unit occurrence rate f(x) of the Gaussian function, the HWHM is the distance between the value of x that makes f(x)=fₘₐₓ/2 and the center. The greater the HWHM is, the greater the number of clusters which the source code units are dispersed across is. The smaller the HWHM is, the smaller the number of clusters which the source code units are concentrated in is. Note that the cluster rank x of the original data used for fitting is an integer, the HWHM calculated by the Gaussian function is not always an integer, but may be a decimal.

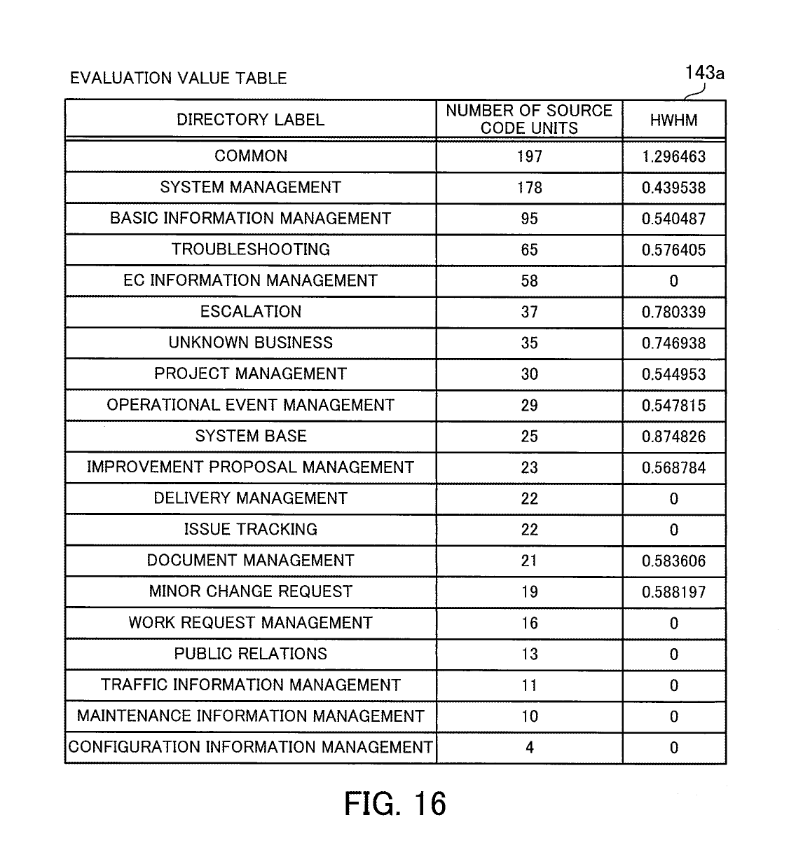

FIG. 16 illustrates a first example of an evaluation value table.

The evaluation value calculation unit 128 calculates a directory evaluation value for each directory, and generates an evaluation value table 143a. The evaluation value table 143a is stored in the visualized information storage unit 125. Further, the evaluation value table 143a is displayed on the display 111.

The evaluation value table 143a includes the following items: directory label, the number of source code units, and HWHM. The directory label is one that described in the label table 136. The number of source code units is the total number of source code units belonging to the directory indicated by the directory label. The number of source code units may be specified from the source code unit count table 137 and the label table 136. The HWHM is a HWHM of the Gaussian function that is calculated in the manner described above, and is a quantitative index of the degree of dispersion of the source code units.

The evaluation value table 143a indicates the analysis results of the same set of source code units as that represented in the heat maps 142a and 142b. The directories other than the directory “COMMON”, which is presumed to be a shared library, have HWHMs less than 1. Accordingly, the architecture represented by the evaluation value table 143a is regarded as a functionally-partitioned (vertically-partitioned) architecture. Further, the discrepancy between the design concept and the current implementation status is determined to be small.

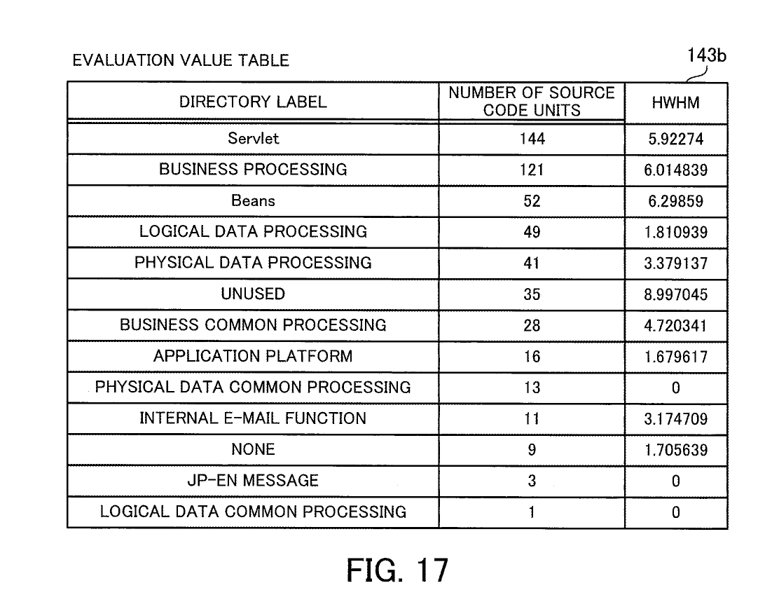

FIG. 17 illustrates a second example of an evaluation value table.

An evaluation value table 143b indicates the analysis results of the same set of source code units as that represented in the heat maps 142c and 142d. The directories other than the directories “PHYSICAL DATA COMMON PROCESSING”, “JP-EN MESSAGE”, and “LOGICAL DATA COMMON PROCESSING” have HWHMs greater than or equal to 1. Accordingly, the architecture represented by the evaluation value table 143b is regarded as a multilayered (horizontally-partitioned) architecture. However, there are directories with HWHMs less than 1, and therefore there may be a discrepancy between the design concept and the current implementation status.

In order to understand the generated evaluation value tables 143a and 143b, for example, the HWHM of each directory is compared to a threshold (for example, threshold=1). If a majority of directories (for example, a certain percentage of directories or more) have HWHMs less than the threshold, the architecture in the initial development stage is determined to be a functionally-partitioned (vertically-partitioned) architecture. In this case, if there is a directory with a HWHM greater than or equal to the threshold, it is likely that maintenance and modifications not conforming to the architecture in the initial development stage have been performed. Thus, there may be a discrepancy between the initial design concept and the current implementation status. On the other hand, if a majority of directories (for example, a certain percentage of directories or more) have HWHMs greater than a threshold, the architecture in the initial development stage is determined to be a multilayered (horizontally-partitioned) architecture. In this case, if there is a directory with a HWHM less than the threshold, it is likely that maintenance and modifications not conforming to the architecture in the initial development stage have been performed. Thus, there may be a discrepancy between the initial design concept and the current implementation status.

The following describes a processing procedure performed by the analysis apparatus 100.

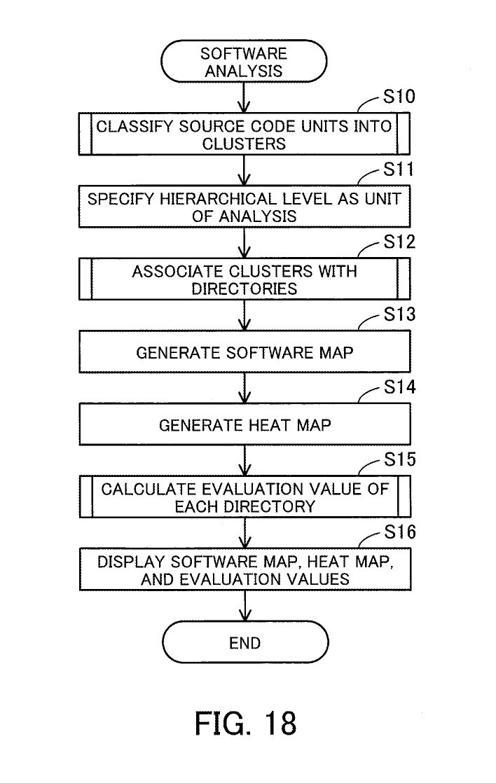

FIG. 18 is a flowchart illustrating an example of the procedure of software analysis.

(S10) The clustering unit 122 reads a set of source code units from the source code storage unit 121, and analyzes the set of source code units. The clustering unit 122 performs clustering to classify the set of source code units into a plurality of clusters. Further, the clustering unit 122 specifies a directory to which each source code unit belongs. The clustering unit 122 generates a cluster table 135 in which the source code units, the directories, and the clusters are associated with each other. The details of clustering will be described below.

(S11) The visualization control unit 124 receives an input for specifying the hierarchical level of directories used as a unit of analysis. The hierarchical level may be input by the analyst, using the input device 112, for example.

(S12) The visualization control unit 124 associates clusters with directories, based on the cluster table 135 generated in step S10. That is, the visualization control unit 124 generates a source code unit count table 137 that indicates the number of source code units of each combination of a directory and a cluster, based on the cluster table 135. The details of association processing will be described below.

(S13) The software map generation unit 126 generates a software map, based on the cluster table 135 generated in step S10. The software map generation unit 126 generates nodes representing the respective source code units described in the cluster table 135. The software map generation unit 126 applies to each node a visual representation corresponding to the directory to which the corresponding source code unit belongs, and places the node in a position corresponding to the cluster to which the corresponding source code unit belongs.

(S14) The heat map generation unit 127 generates a heat map, based on the source code unit count table 137 generated in step S12. The heat map generation unit 127 generates, for each combination of a directory and a cluster, a symbol corresponding to the number of source code units, and places the symbol in a position specified by the row corresponding to the directory and the column corresponding to the cluster. The symbol may be, for example, a binary symbol indicating whether there is a corresponding source code unit, or a multivalued symbol having a different visual representation depending on the number of source code units.

(S15) The evaluation value calculation unit 128 generates a directory evaluation value of each directory, based on the source code unit count table 137 generated in step S12. The directory evaluation value is the HWHM of the Gaussian function representing the source code unit occurrence rate f(x) with respect to the cluster rank x. The evaluation value calculation unit 128 generates an evaluation value table including directory evaluation values of the respective plurality of directories. The details of evaluation value calculation will be described below.

(S16) The visualization control unit 124 causes the display 111 to display the software map generated in step S13, the heat map generated in step S14, and the evaluation value table generated in step S15. Note that steps S13 to S15 may be performed in an arbitrary order, or may be performed in parallel.

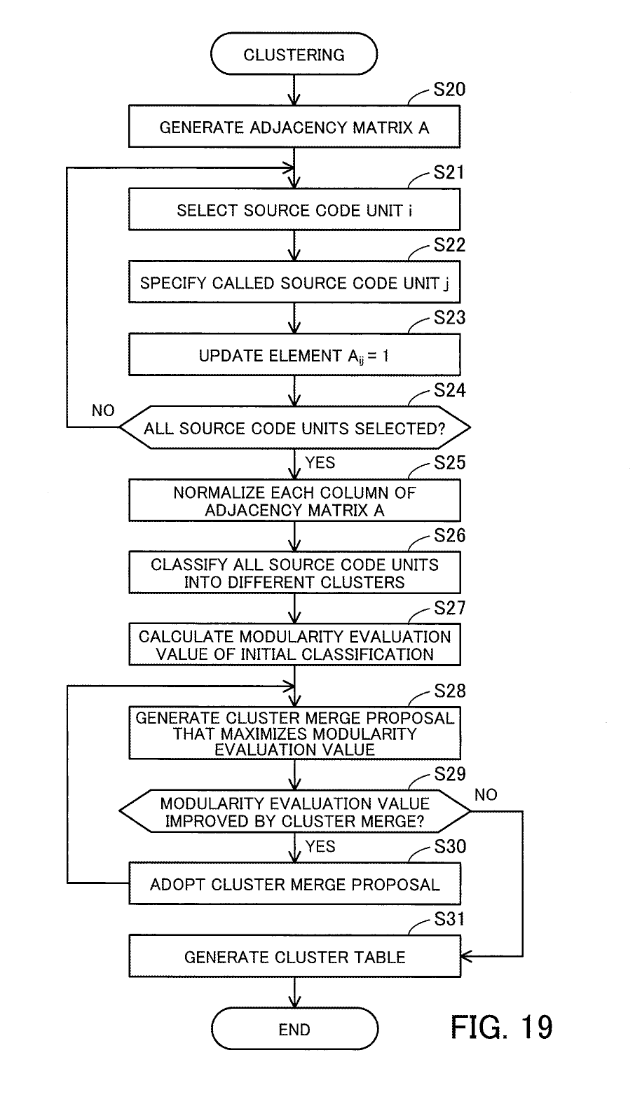

FIG. 19 is a flowchart illustrating an example of the procedure of clustering.

The clustering is performed in step S10 described above.

(S20) The clustering unit 122 counts the number of source code units stored in the source code storage unit 121. The clustering unit 122 generates a square matrix where each edge corresponds to the number of source code units, as an empty adjacency matrix 133 (adjacency matrix A)

(S21) The clustering unit 122 selects a source code unit i.

(S22) The clustering unit 122 extracts a method call from the source code unit i, and specifies a source code unit j describing a called unit of processing.

(S23) The clustering unit 122 updates an element in the i-th row and j-th column (element Aᵢⱼ) of the adjacency matrix 133 generated in step S20 to “1”.

(S24) The clustering unit 122 determines whether all the source code units have been selected in step S21. If all the source code units have been selected, the process proceeds to step S25. Otherwise, the process returns to step S21.

(S25) The clustering unit 122 normalizes each column of the adjacency matrix 133. More specifically, the clustering unit 122 counts the number (K) of elements of “1” in each column of the adjacency matrix 133, and updates the elements of “1” to “1/K”.

(S26) The clustering unit 122 generates the same number of clusters as the number of source code units as temporary clusters, and classifies the plurality of source code units into different clusters.

(S27) The clustering unit 122 calculates a modularity evaluation value Q using the equation (1) described above, based on the results of the clustering of step S26.

(S28) The clustering unit 122 selects two clusters from the current clustering results, and generates a cluster merge proposal for merging the selected two clusters. The clustering unit 122 calculates the modularity evaluation value Q to be obtained when the cluster merge proposal is adopted. The clustering unit 122 repeats generation of a cluster merge proposal and calculation of a modularity evaluation value Q for each selection pattern of selecting two clusters from the current clustering results, and specifies a cluster merge proposal that maximizes the modularity evaluation value Q.

(S29) The clustering unit 122 determines whether the modularity evaluation value Q to be obtained when the cluster merge proposal specified in step S28 is adopted is improved from the modularity evaluation value Q of the current clustering results (for example, the former is greater than the latter). If the modularity evaluation value Q is improved, the process proceeds to step S30. If the modularity evaluation value Q remains the same or drops, the process proceeds to step S31.

(S30) The clustering unit 122 adopts the cluster merge proposal specified in step S28, and merges the two clusters. Then, the clustering results after the merge are held as the current clustering results, and the process returns to step S28.

(S31) The clustering unit 122 does not adopt the cluster merge proposal specified in step S28, and retains the current clustering results. Further, the clustering unit 122 specifies a directory to which each source code unit belongs. For example, the clustering unit 122 extracts the package name from each source code unit. Then, the clustering unit 122 generates a cluster table 135 in which the source code units, the directories, and the clusters are associated with each other.

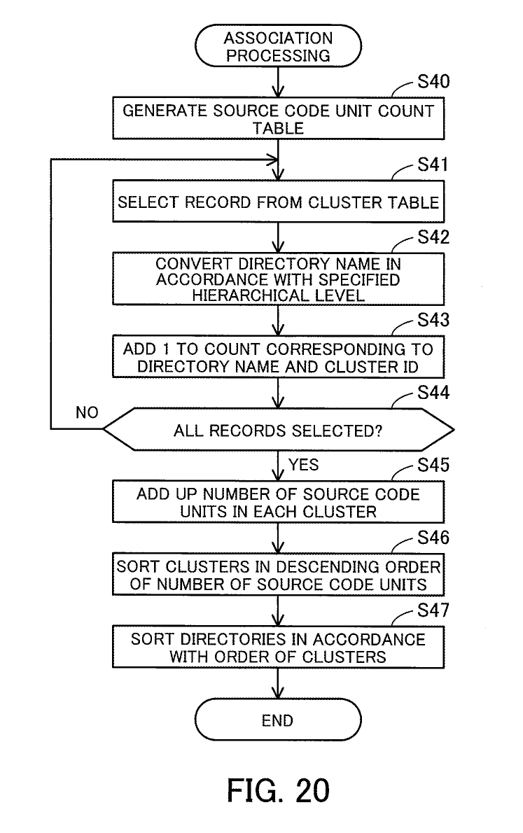

FIG. 20 is a flowchart illustrating an example of the procedure of association processing.

The association processing is performed in step S12 described above.

(S40) The visualization control unit 124 extracts directories at the hierarchical level specified in step S11, from the cluster table 135 generated in step S31, and counts the number of directories. Further, the visualization control unit 124 extracts clusters from the cluster table 135, and counts the number of clusters. The visualization control unit 124 generates an empty source code unit count table 137, based on the number of directories and the number of clusters.

(S41) The visualization control unit 124 selects a record from the cluster table 135.

(S42) The visualization control unit 124 converts the directory name included in the record selected in step S41 into a directory name corresponding to the specified hierarchical level. More specifically, the visualization control unit 124 deletes the names of the subdirectories below the specified hierarchical level from the directory name included in the selected record.

(S43) The visualization control unit 124 selects an element specified by the directory name converted in step S42 and the cluster ID included in the selected record, from the source code unit count table 137 generated in step S40. The visualization control unit 124 adds 1 to the value of the selected element (the number of source code units).

(S44) The visualization control unit 124 determines whether all the records included in the cluster table 135 have been selected in step S41. If all the records have been selected, the process proceeds to step S45. Otherwise, the process returns to step S41.

(S45) The visualization control unit 124 adds up the number of source code units in each column of the source code unit count table 137, that is, each cluster.

(S46) The visualization control unit 124 sorts the clusters in descending order of the total number of source code units.

(S47) The visualization control unit 124 sorts the directories in accordance with the order of clusters such that the symbols in the heat map generated in step S14 are arranged diagonally. For example, the visualization control unit 124 sorts the directories such that, among the directories with source code units belonging to a certain cluster, the directory with the maximum number of source code units is assigned a rank corresponding to the rank of the cluster.

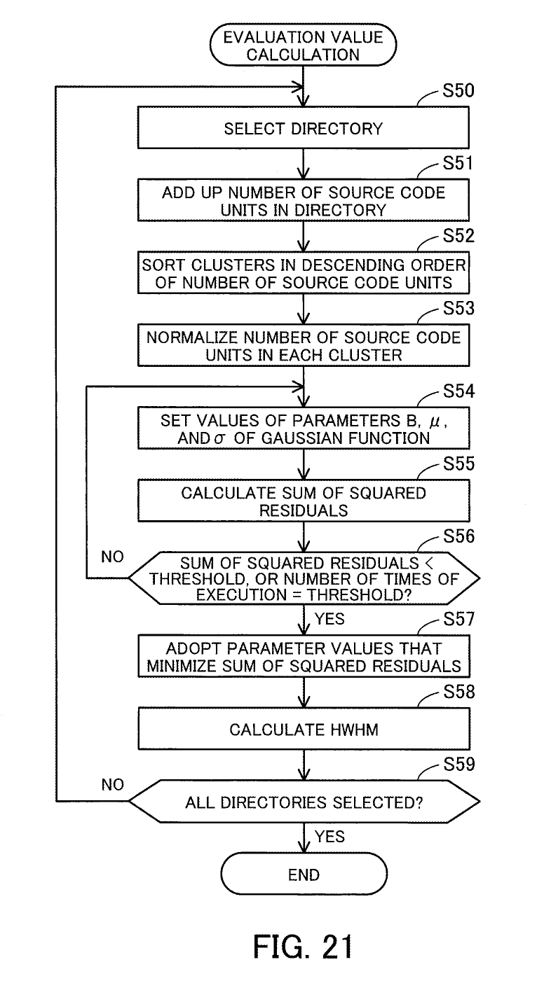

FIG. 21 is a flowchart illustrating an example of the procedure of evaluation value calculation.

The evaluation value calculation is performed in step S15 described above.

(S50) The evaluation value calculation unit 128 selects one of the directories from the source code unit count table 137 generated in steps S40 to S47.

(S51) The evaluation value calculation unit 128 adds up, for the directory selected in step S50, the number of source code units in the corresponding row of the source code unit count table 137. That is, the evaluation value calculation unit 128 calculates the total number of source code units belonging to the selected directory.

(S52) The evaluation value calculation unit 128 sorts, for the directory selected in step S50, the clusters in descending order of the number of source code units, based on the number of source code units of each cluster.

(S53) The evaluation value calculation unit 128 normalizes the number of source code units of each cluster. That is, the evaluation value calculation unit 128 converts the number of source code units of each cluster into the source code unit occurrence rate, by dividing the number of source code units of the cluster by the total number of source code units calculated in step S51.

(S54) The evaluation value calculation unit 128 sets the values of the coefficient B, the mean μ, and the standard deviation σ, which are the parameters of the Gaussian function. For example, in the first calculation, the parameter values are set to predetermined values, such as the coefficient B=1, μ,=1, and σ=1. In the second and subsequent calculations, the evaluation value calculation unit 128 may change the values of the parameters randomly, or may change the values of the parameters using a method that reduces the sum of squared residuals with reference to the sum of squared residuals calculated in previously performed step S55.

(S55) The evaluation value calculation unit 128 specifies a Gaussian function that represents the corresponding relationship between the cluster rank x and the source code unit occurrence rate f(x), using the values of the parameters that are set in step S54. The evaluation value calculation unit 128 calculates the sum of squared residuals between the estimated source code unit occurrence rate indicated by the specified Gaussian function and the actual source code unit occurrence rate calculated in step S53. The sum of squared residuals is an index of how well the Gaussian function is fitted.

(S56) The evaluation value calculation unit 128 determines whether the sum of squared residuals calculated in step S55 is less than a predetermined threshold, that is, whether an appropriate Gaussian function is obtained. Further, the evaluation value calculation unit 128 determines whether steps S54 and S55 have been executed a predetermined threshold number of times, that is, whether the search for a Gaussian function has been repeated a sufficiently large number of times. If at least one of the above two conditions is satisfied, the process proceeds to step S57. If none of the above two conditions is satisfied, the process returns to step S54.

(S57) The evaluation value calculation unit 128 adopts the values of the parameters that minimize the sum of squared residuals calculated in step S55, and thereby determines the Gaussian function. Note that although fitting of the Gaussian function is performed by trial and error in FIG. 21, fitting may be performed using another method.

(S58) The evaluation value calculation unit 128 calculates the HWHM of the Gaussian function determined in step S57 as the directory evaluation value of the directory selected in step S50. That is, the evaluation value calculation unit 128 calculates the maximum value fₘₐₓ of the source code unit occurrence rate of the Gaussian function, and calculates the distance between the value of x that makes f(x)=fₘₐₓ/2 and the center.

The evaluation value calculation unit 128 detects a directory label corresponding to the directory selected in step S50, from the label table 136. The evaluation value calculation unit 128 registers the detected directory label, the number of source code units calculated in step S51, and the HWHM calculated in step S58 in association with each other in the evaluation table.

(S59) The evaluation value calculation unit 128 determines whether all the directories indicated in the source code unit count table 137 have been selected in step S50. If all the directories have been selected, the evaluation value calculation ends. Otherwise, the process returns to step S50.

According to the analysis apparatus 100 of the second embodiment, information on directories to which source code units belong is acquired as information on design concept, and information on clusters is acquired as information on functions of application software, based on calling relationships between source code units. Further, as visualized information in which relationships between directories and functions are visualized, a software map, a heat map, and an evaluation value table are generated and displayed.

Accordingly, it is possible to obtain an overview of the architecture of the application software. Further, even if design information is no longer stored, it is easy to understand the design concept employed in the initial stage of development. Further, it is easy to detect a discrepancy between the design concept employed in the initial stage and the current implementation status, and it is possible to evaluate whether maintenance and modifications that have been performed are appropriate. Further, it is easy to identify inappropriate maintenance and modifications. Further, the degree of discrepancy between the design concept and the implementation status is quantitatively calculated. Therefore, persuasive analysis information is provided, so that it is easy to make a comparison between different pieces of application software.

As mentioned above, the information processing in the first embodiment may be implemented by causing the analysis apparatus 10 to execute a program. The information processing of the second embodiment may be implemented by causing the analysis apparatus 100 to execute a program.

Each of the programs may be recorded in a computer-readable storage medium (for example, the storage medium 113). Examples of storage media include magnetic disks, optical discs, magneto-optical disks, semiconductor memories, and the like. Examples of magnetic disks include FD and HDD. Examples of optical discs include CD, CD-Recordable (CD-R), CD-Rewritable (CD-RW), DVD, DVD-R, and DVD-RW. The program may be stored in a portable storage medium and distributed. In this case, the program may be executed after being copied from the portable storage medium to another storage medium (for example, the HDD 103).

According to one aspect, it is possible to provide a quantitative evaluation on the overall structure of software.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An analysis method comprising:
detecting, by a processor, dependency relationships between a plurality of code units describing processing performed by software, classifying the plurality of code units into a plurality of clusters, based on the dependency relationships, and acquiring directory information indicating which of a plurality of directories each of the plurality of code units belongs to;
counting, by the processor, for at least one directory of the plurality of directories indicated by the directory information, a number of code units belonging to the one directory in each of the plurality of clusters; and
calculating, by the processor, an evaluation value indicating a dispersion status of the code units belonging to the one directory, based on a distribution of the number of code units among the plurality of clusters.

2. The analysis method according to claim 1, wherein for each of the plurality of directories including the one directory, the number of code units in each of the plurality of clusters is calculated, and the evaluation value is calculated.

3. The analysis method according to claim 2, further comprising generating, by the processor, a map including a first axis corresponding to the plurality of directories and a second axis corresponding to the plurality of clusters, in which for each combination of one of the directories and one of the clusters, a symbol corresponding to the number of code units in the combination is arranged in a position corresponding to the combination.

4. The analysis method according to claim 1, wherein the evaluation value is a value related to a number of clusters including a threshold number of code units or more.

5. An analysis apparatus comprising:
a memory configured to store a plurality of code units describing processing performed by software, and directory information indicating which of a plurality of directories each of the plurality of code units belongs to; and
a processor configured to perform a procedure including:
detecting dependency relationships between the plurality of code units, and classifying the plurality of code units into a plurality of clusters, based on the dependency relationships,
counting, for at least one directory of the plurality of directories indicated by the directory information, a number of code units belonging to the one directory in each of the plurality of clusters, and
calculating an evaluation value indicating a dispersion status of the code units belonging to the one directory, based on a distribution of the number of code units among the plurality of clusters.

6. A non-transitory computer-readable storage medium storing a computer program that causes a computer to perform a procedure comprising:
detecting dependency relationships between a plurality of code units describing processing performed by software, classifying the plurality of code units into a plurality of clusters, based on the dependency relationships, and acquiring directory information indicating which of a plurality of directories each of the plurality of code units belongs to;
counting, for at least one directory of the plurality of directories indicated by the directory information, a number of code units belonging to the one directory in each of the plurality of clusters; and
calculating an evaluation value indicating a dispersion status of the code units belonging to the one directory, based on a distribution of the number of code units among the plurality of clusters.
